(19) United States
(12) Patent Application Publication
(10) Pub. No.: US 2022/0383727 A1
(43) Pub. Date: Dec. 1, 2022

(54) Personal Proximity Warning Device

(71) Applicant: Melinda Newman, Glendale, AZ (US)

(72) Inventor: Melinda Newman, Glendale, AZ (US)

(21) Appl. No.: 17/752,363

(22) Filed: May 24, 2022

Related U.S. Application Data
(60) Provisional application No. 63/193,066, filed on May 26, 2021.

(51) Int. Cl. G08B 25/01; H04W 4/90; H04W 4/02; G01S 13/56; H04R 1/10

(52) U.S. Cl. CPC G08B 25/016; H04W 4/90; H04W 4/025; G01S 13/56; H04R 1/1091

(57) ABSTRACT

A personal proximity warning device for warning a user of a rear approach of a person includes a housing that is removably attachable to an item worn by the user. A camera and a sensor attached to the housing capture an image of and sense motion within an area proximate to the user. A battery, a transceiver, and a microprocessor are positioned in the housing. The microprocessor selectively actuates the camera and the transceiver to capture and transmit the image of the area, respectively, and actuates the transceiver to transmit an alert. Programming code, which is selectively positionable on an electronic device of the user, enables the electronic device to receive the alert and the image, to override audio to earbuds being worn by the user, and to broadcast the alert to the user via the earbuds.

### CROSS-REFERENCE TO RELATED APPLICATIONS

I hereby claim the benefit under 35 U.S.C. Section 119(e) of U.S. Provisional application 63/193,066 filed May 26, 2021

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention

The disclosure relates to warning devices and more particularly pertains to a new warning device for warning a user of a rear approach of a person. The present invention discloses a warning device for use with a user's cellphone that senses object approaching from a rear of the user and warns the user via earbuds communicatively engaged to the cellphone.

(2) Description of Related Art Including Information Disclosed Under 37 CFR 1.97 and 1.98.

The prior art relates to warning devices. Prior art warning devices may comprise helmet mounted rear approach warning devices, and rear facing sensor and camera combinations paired with user's phones. What is lacking in the prior art is a warning device comprising a housing to which a camera and a sensor are attached in combination with programming code on an electronic device of the user that enables the electronic device to receive an alert and an image, to override audio to earbuds being worn by the user, and to broadcast an alert to the user via the earbuds.

### BRIEF SUMMARY OF THE INVENTION

An embodiment of the disclosure meets the needs presented above by generally comprising a housing, which is configured to be attachable to an item worn by a user so that the housing is removably attached to the item. A camera and a sensor are attached to a front of the housing and are configured to capture an image of and to sense motion within an area proximate to the user. A battery, a transceiver, and a microprocessor are positioned in the housing. The microprocessor is operationally engaged to the battery, the camera, the sensor, and the transceiver. The microprocessor is enabled to selectively actuate the camera and the transceiver to capture and transmit the image of the area, respectively, and to actuate the transceiver to transmit an alert. Programming code, which is selectively positionable on an electronic device of the user, enables the electronic device to receive the alert and the image, to override audio to earbuds, which are worn by the user and operationally engaged to the electronic device, and to broadcast the alert to the user via the earbuds.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a personal proximity warning device according to an embodiment of the disclosure.

FIG. 2 is a rear view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

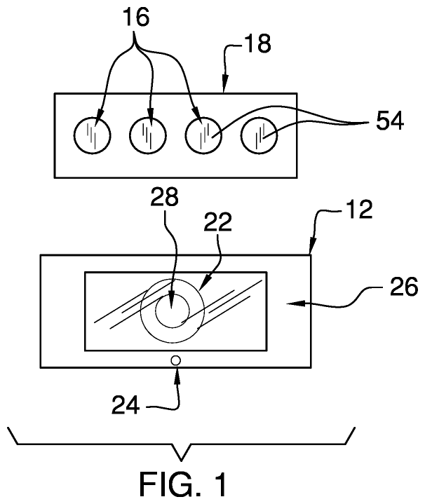

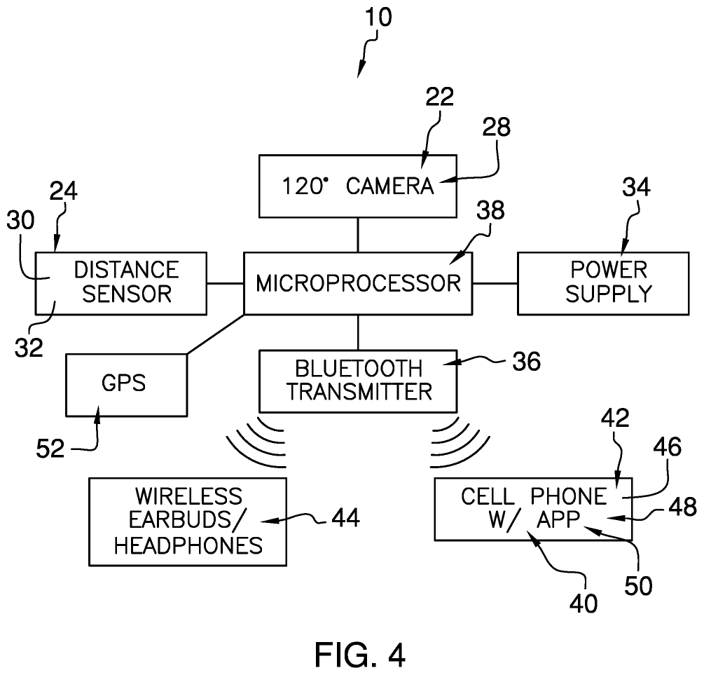

With reference now to the drawings, and in particular to FIGS. 1 through 4 thereof, a new warning device embodying the principles and concepts of an embodiment of the disclosure and generally designated by the reference numeral 10 will be described.

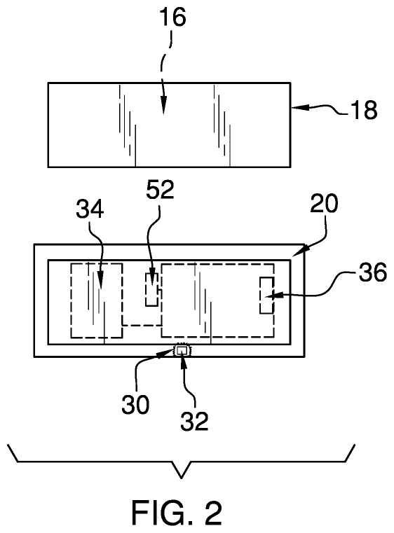

As best illustrated in FIGS. 1 through 4, the personal proximity warning device 10 generally comprises a housing 12, which is configured to be attachable to an item 14 worn by a user so that the housing 12 is removably attached to the item 14. A fastener 16 is attached to the housing 12 and is configured to selectively attach to the item 14 worn by the user, such as a shirt, a pullover, a jacket, or the like, so that the housing 12 is removably attached to the item 14. The fastener 16 may comprise a clip 18, as shown in FIG. 1, hook and loop fasteners, pressure sensitive adhesives, and the like. As shown in FIGS. 1 and 2, the clip 18 is magnetic, by means of a plurality of magnets 54, and the housing 12 is paramagnetic so that the clip 18 is selectively magnetically attachable to a back 20 of the housing 12.

A camera 22 and a sensor 24 are attached to a front 26 of the housing 12 and are configured to capture an image of and to sense motion within an area proximate to the user. The camera 22 may be configured to capture a video and may comprise a wide angle lens 28. The sensor 24 is programmable to detect motion within a specified range of the user. The sensor 24 may comprise a radar emitter 30 and a radar receiver 32, an infrared sensor, or the like. With the sensor 24 comprising a radar emitter 30 and a radar receiver 32, it is configured to determine a direction and speed, relative to the user, of an object, such a potentially threatening person or animal, within the area.

A battery 34, a transceiver 36, and a microprocessor 38 are positioned in the housing 12. The microprocessor 38 is operationally engaged to the battery 34, the camera 22, the sensor 24, and the transceiver 36. The microprocessor 38 is enabled to selectively actuate the camera 22 and the transceiver 36 to capture and transmit the image of the area, respectively, and to actuate the transceiver 36 to transmit an alert.

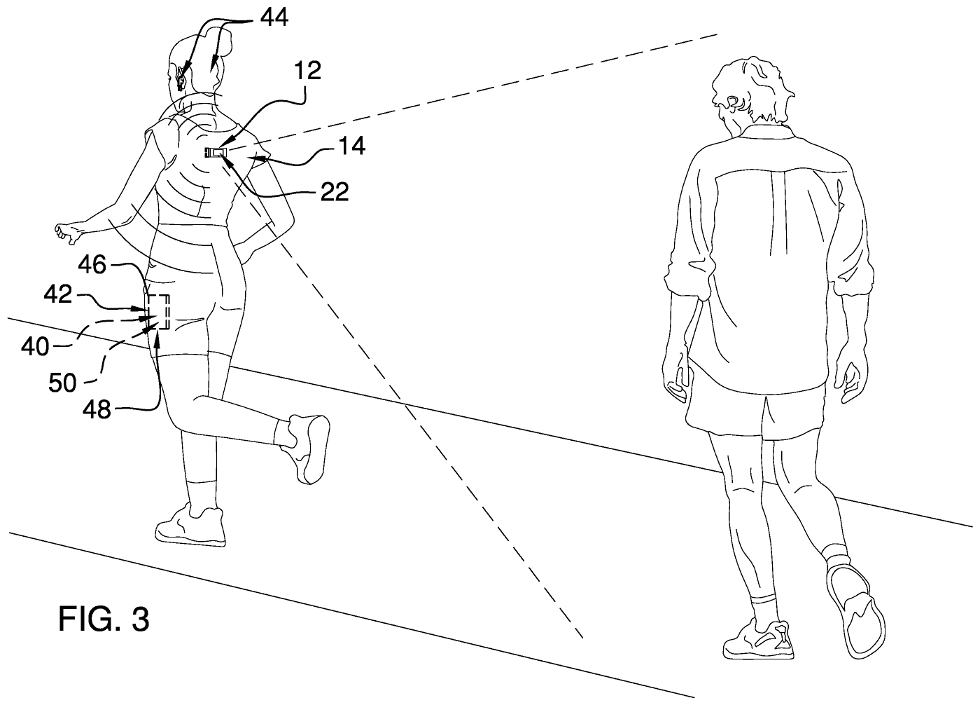

Programming code 40, which is selectively positionable on an electronic device 42 of the user, enables the electronic device 42 to receive the alert and the image, to override audio to earbuds 44, which are worn by the user and which are operationally engaged to the electronic device 42, and to broadcast the alert to the user via the earbuds 44. As shown in FIG. 3, the Programming code 40 is positioned on a cellphone 46 and the earbuds 44 are wireless. The present invention anticipates the electronic device 42 comprising a dedicated unit, a music player, or the like. The present invention also anticipates the earbuds 44 being wiredly engaged to the electronic device 42.

The Programming code 40 also enables the electronic device 42 to selectively initiate a call to emergency services and to transmit a name of the user, the location of the electronic device 42, and a nature of the call. The personal proximity warning device 10 also may comprise a Global Positioning System (GPS) transceiver 54, which would enable transmission of a location of the personal proximity warning device 10. This would be useful when the electronic device 42 does not have a locating system, such as GPS. The programming code 40 enables the electronic device 42 to selectively send the image and a location of the electronic device 42 to one or both of emergency services and an emergency contact. While the present invention is anticipated to be of particular use in warning the user of the approach of a potentially threatening person or animal, the present invention also anticipates two personal proximity warning devices 10 being attached to the item 14 worn by the user and being directed one to the rear and one to the front of the user.

The Programming code 40 enables the electronic device 42 to selectively actuate a microphone 48 of the electronic device 42, to record audio, and to store an audiovisual file on a data storage module 50 of the electronic device 42. The Programming code 40 also enables the electronic device 42 to selectively send the audiovisual file and the location of the electronic device 42 to one or both of emergency services and the emergency contact.

The Programming code 40 enables the electronic device 42 to utilize voice command to override the alert. The Programming code 40 also enables the electronic device 42 to allow for user selection of a coverage area for the sensor 24 and an emergency contact, and to communicate the coverage area to the microprocessor 38 via the transceiver 36.

In use, the housing 12 is clipped to the item 14 being worn by the user. When the sensor 24 senses motion within the area proximate to the user, typically to the rear of the user, the microprocessor 38 actuates the camera 22 and the transceiver 36 to capture and transmit the image of the area, respectively, and actuates the transceiver 36 to transmit the alert. The alert is broadcast to the user via the earbuds 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal proximity warning device comprising:
a housing configured to be attachable to an item worn by a user, such that the housing is removably attached to the item;
a camera attached to a front of the housing and being configured for capturing an image of an area proximate to the user;
a sensor attached to the front of the housing and being configured for sensing motion within the area proximate to the user;
a transceiver positioned in the housing;
a microprocessor positioned in the housing and operationally engaged to the camera, the sensor, and the transceiver, such that the microprocessor is enabled for selectively actuating the camera and the transceiver for capturing and transmitting the image of the area, respectively, and for actuating the transceiver for transmitting an alert;
a battery positioned in the housing and operationally engaged to the microprocessor; and
programming code selectively positionable on an electronic device of the user, enabling the electronic device for receiving the alert and the image, for overriding audio to earbuds worn by the user and operationally engaged to the electronic device, and for broadcasting the alert to the user via the earbuds.

2. The personal proximity warning device of claim 1, further including a fastener attached to the housing and being configured for selectively attaching to the item worn by the user, such that the housing is removably attached to the item.

3. The personal proximity warning device of claim 2, wherein the fastener comprises a clip.

4. The personal proximity warning device of claim 3, wherein the clip being magnetic, the housing being paramagnetic, such that the clip is selectively magnetically attachable to a back of the housing.

5. The personal proximity warning device of claim 1, wherein the camera is configured to capture a video.

6. The personal proximity warning device of claim 1, wherein the camera comprises a wide angle lens.

7. The personal proximity warning device of claim 1, wherein the sensor is programmable to detect a motion within a specified range of the user.

8. The personal proximity warning device of claim 1, wherein the sensor comprises a radar emitter and radar receiver, wherein the sensor is configured to determine a direction and speed, relative to the user, of an object within the area.

9. The personal proximity warning device of claim 1, wherein the programming code enables the electronic device to selectively initiate a call to emergency services and to transmit a name of the user, the location of the electronic device, and a nature of the call.

10. The personal proximity warning device of claim 1, wherein the programming code enables the electronic device to selectively send the image and a location of the electronic device to one or both of emergency services and an emergency contact.

11. The personal proximity warning device of claim 1, wherein the programming code enables the electronic device to selectively actuate a microphone of the electronic device, to record audio, and to store an audiovisual file on a data storage module of the electronic device.

12. The personal proximity warning device of claim 11, wherein the programming code enables the electronic device to selectively send the audiovisual file and the location of the electronic device to one or both of emergency services and the emergency contact.

13. The personal proximity warning device of claim 1, wherein the programming code enables the electronic device to utilize voice command to override of the alert.

14. The personal proximity warning device of claim 1, wherein the programming code enables the electronic device for user selection of a coverage area for the sensor and an emergency contact and for communicating the coverage area to the microprocessor via the transceiver.

15. A personal proximity warning system comprising:
a housing configured to be attachable to an item worn by a user, such that the housing is removably attached to the item;
a camera attached to a front of the housing and being configured for capturing an image of an area proximate to the user;
a sensor attached to the front of the housing and being configured for sensing motion within the area proximate to the user;
a transceiver positioned in the housing;
a microprocessor positioned in the housing and operationally engaged to the camera, the sensor, and the transceiver, such that the microprocessor is enabled for selectively actuating the camera and the transceiver for capturing and transmitting the image of the area, respectively, and for actuating the transceiver for transmitting an alert;
a battery positioned in the housing and operationally engaged to the microprocessor;
an electronic device in possession of the user;
earbuds worn by the user and operationally engaged to the electronic device; and
programming code positioned on the electronic device enabling the electronic device for receiving the alert and the image, for overriding audio to the earbuds, and for broadcasting the alert to the user via the earbuds.

16. A personal proximity warning device comprising:
a housing configured to be attachable to an item worn by a user, such that the housing is removably attached to the item;
a fastener attached to the housing and being configured for selectively attaching to the item worn by the user, such that the housing is removably attached to the item, the fastener comprising a clip, the clip being magnetic, the housing being paramagnetic, such that the clip is selectively magnetically attachable to a back of the housing;
a camera attached to a front of the housing and being configured for capturing an image of an area proximate to the user, the camera being configured for capturing a video, the camera comprising a wide angle lens;
a sensor attached to the front of the housing and being configured for sensing motion within the area proximate to the user, the sensor being programmable for detecting a motion within a specified range of the user, the sensor comprising a radar emitter and radar receiver, wherein the sensor is configured for determining a direction and speed, relative to the user, of an object within the area;
a transceiver positioned in the housing;
a microprocessor positioned in the housing and operationally engaged to the camera, the sensor, and the transceiver, such that the microprocessor is enabled for selectively actuating the camera and the transceiver for capturing and transmitting the image of the area, respectively, and for actuating the transceiver for transmitting an alert;
a battery positioned in the housing and operationally engaged to the microprocessor; and
programming code selectively positionable on an electronic device of the user, enabling the electronic device for receiving the alert and the image, for overriding audio to earbuds worn by the user and operationally engaged to the electronic device, and for broadcasting the alert to the user via the earbuds, the programming code enabling the electronic device for selectively initiating a call to emergency services and transmitting a name of the user, the location of the electronic device, and a nature of the call, the programming code enabling the electronic device for selectively sending the image and a location of the electronic device to one or both of emergency services and an emergency contact, the programming code enabling the electronic device for selectively actuating a microphone of the electronic device, for recording audio, and for storing an audiovisual file on a data storage module of the electronic device, the programming code enabling the electronic device for selectively sending the audiovisual file and the location of the electronic device to one or both of emergency services and the emergency contact, the programming code enabling the electronic device for utilizing voice command for overriding of the alert, the programming code enabling the electronic device for user selection of a coverage area for the sensor and an emergency contact and for communicating the coverage area to the microprocessor via the transceiver.
